(19) United States
(12) Patent Application Publication
(10) Pub. No.: US 2012/0246065 A1
(43) Pub. Date: Sep. 27, 2012

(54) TECHNIQUES FOR OFFERING CONTEXT TO SERVICE PROVIDERS UTILIZING INCENTIVES

(76) Inventors: Mark D. Yarvis, Portland, OR (US); Matthew D. Wood, Portland, OR (US); Bernard N. Keany, Lake Oswego, OR (US); David A. Sandage, Forest Grove, OR (US); Thomas W. Stroebel, San Jose, CA (US)

(21) Appl. No.: 13/129,968

(22) PCT Filed: Dec. 18, 2009
(86) PCT No.: PCT/US09/68689

§ 371 Date: May 18, 2011

(51) Int. Cl. G06Q 99/00; G06Q 40/00

(52) U.S. Cl. 705/39; 705/1.1

(57) ABSTRACT

An embodiment of the present invention provides a method of offering incentive based context to service providers, comprising capturing context information of a user and distributing said context information to said service provider, wherein said service provider provides an incentive to said user for said context information, and wherein said user may choose all or a subset of said context information for varying types of compensation selected from the group consisting of: No compensation; Direct monetary compensation; Indirect monetary compensation; Non-monetary compensation; or Points, credits, access to free content.

### BACKGROUND

The rapid development of wireless devices and their ever-improving mobile capabilities have enabled users to depend on them for increasing numbers of applications while the devices can obtain vast personal information. Users of such devices are increasingly able to capture contextual information about their environment, their interactions, and themselves on various platforms. These platforms include, but are not limited to, mobile computing/communication devices (e.g., PDAs, phones, MIDs), fixed and portable computing devices (laptops, desktops, and set-top-boxes), and cloud computing services and platforms. Both raw context and profiles derived from this context have a potentially high value to the user, if the user can properly manage and share this information with service providers. Service providers may use this information to better tailor offers to the user, to better understand their customers, or to repackage and sell (or otherwise monetize).

The user potentially stands to benefit through a better service experience or through a specific incentive. The user's ability to leverage this context is currently limited in the following ways: there is no automated way to share, combine, or integrate context across platforms owned by the same user; there is no automated and/or standardized way for the user to share this context with service providers, with or without compensation; and there is no simple mechanism for controlling access to context.

Further, many users may have multiple personal devices. Those devices each may independently collect information about the user, including explicit user preferences, how they use the device, what data they store and access via the device, and information about the user (what appointments they have on their calendar, where they go physically, what activities they do, what they buy, etc). Typically this information is held independently on each device.

Thus, a strong need exists for a management architecture capable of defining mechanisms that allow users to manage their context and derived profiles across their devices and to control delivery of context and derived profiles to services providers. Further, a strong need exists for a technique to unify the personal information about a user that is gathered on their collection of personal devices.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 depicts a management architecture according to embodiments of the present invention;

FIG. 2 depicts an example of context delivery to service providers according to embodiments of the present invention; and

FIG. 3 shows bundle protection and access protocol according to embodiments of the present invention.

It will be appreciated that for simplicity and clarity of illustration, elements illustrated in the figures have not necessarily been drawn to scale. For example, the dimensions of some of the elements are exaggerated relative to other elements for clarity. Further, where considered appropriate, reference numerals have been repeated among the figures to indicate corresponding or analogous elements.

### DETAILED DESCRIPTION

In the following detailed description, numerous specific details are set forth in order to provide a thorough understanding of the invention. However, it will be understood by those skilled in the art that the preset invention may be practiced without these specific details. In other instances, well-known methods, procedures, components and circuits have not been described in detail so as not to obscure the present invention.

Although embodiments of the invention are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. For example, “a plurality of stations” may include two or more stations.

As mentioned above, users are increasingly capable of capturing contextual information about their environment, their interactions, and themselves on various platforms. These platforms may include, but are not limited to, mobile computing/communication devices (e.g., PDAs, phones, MIDs), fixed and portable computing devices (laptops, desktops, and set-top-boxes), and cloud computing services and platforms. Both raw context and profiles derived from this context have a potentially high value to the user, if the user can properly manage and share this information with service providers. Further, embodiments of systems of the present invention may provide a platform that is an information assimilation and communication platform.

Embodiments of the present invention may solve the limitations of no automated way to share, combine, or integrate context across platforms owned by the same user; no automated and/or standardized way for the user to share this context with service providers, with or without compensation; and no simple mechanism for controlling access to context. Embodiments of the present invention may define mechanisms that allow users to manage their context and derived profiles across their devices and to control delivery of context and derived profiles to services providers.

To exemplify, a user's mobile device may use location context to determine where he is at any given moment. Over time, this context identifies places that he visits often, allowing a user profile to be built. The device might include in this profile a set of restaurants the user goes to frequently and the types of food he enjoys. It may even know when and with whom he tends to eat at each restaurant, creating additional context for his profile. With user consent, this profile may be shared with other devices, including his home PC. Using this PC, the user leverages an online restaurant rating service to look for a restaurant to dine at next week. With his permission, the user's profile is shared with the service, allowing the service to bias search results according to the user's preferences. In addition, the site is able to serve up ads to particular restaurants that are targeted for this user. The site also tracks the demographics of the users who visit the site, in order to boost advertising revenue. Some of the revenue for these ads may be delivered to the user, directly or in the form of other compensation for sharing profile data.

Context collected on user devices may be utilized by service providers either to provide responses to a user's service request (e.g., by knowing the location, preferences, or purchasing goals of the user) or to improve the service in aggregate (e.g., by better understanding their clientele). The user typically is more motivated to share some of their personal context if they get something return, perhaps better service, monetary reward, or non-monetary reward (e.g., loyalty program points). Architectures of the present invention may enable, just to name a few: (1) A user to specify a release policy for the user's context, which indicates what payment is required for different levels of context release to specific service providers; (2) A service provider to specify a payment policy that indicates the types of context desired and the level of payments that will be provided in return; (3) A service-oriented negotiation between the payment policy of the service provider and the release policy of the user to ensure a match between user and service provider interest; (4) Delivery of a “context bundle” from the user's device to the service provider which contains the context desired by the service provider in a form that is protected from release to anyone other than the provider specified by the user and only once any payment promised to the user has been delivered (In an embodiment of the present invention, the “context bundle” may be double encrypted to ensure that the context is delivered only to the desired service provider and only when the desired conditions are met); and (5) Validation by an approval service that the terms of context release to the service provider have been met (and perhaps that the approval service has also been compensated). The approval service may provide a key to the service provider that allows the bundle contents to be obtained.

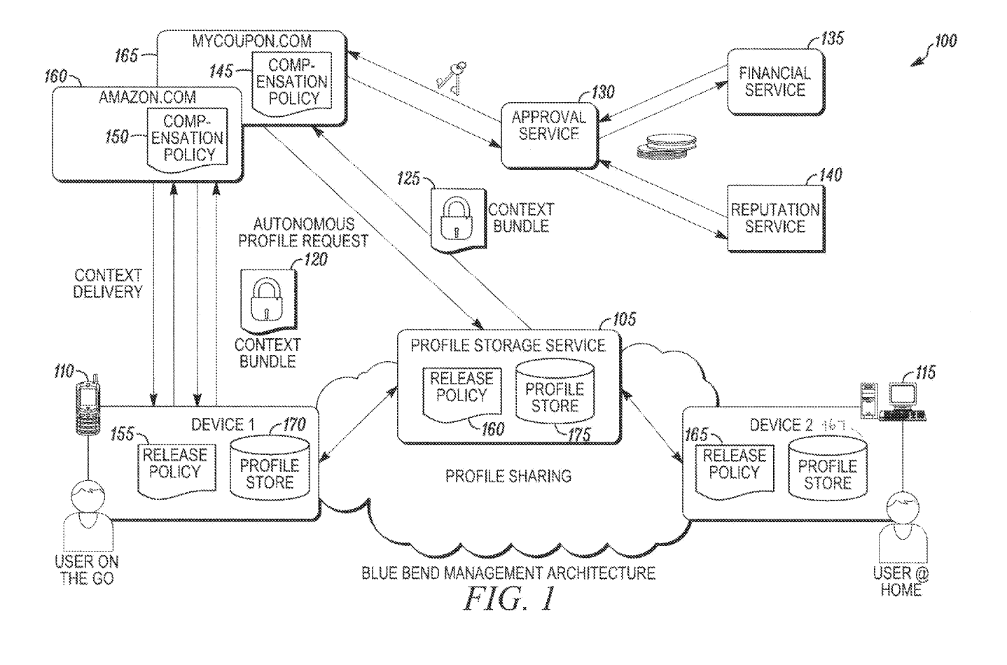

A high-level view of an architecture of an embodiment of the present invention is provided generally as 100 of FIG. 1. It may consist of two main components: profile storage and distribution, and context delivery. Each of these components is described in more detail below.

A user may utilize multiple computing and communication devices (such as device 1 110 and device 2 115, each of which may obtain context about the user's environment, their interactions, and themselves. Some devices such as PDAs, phones, and MIDs might be in the best position to identify context about the user's actions and interactions in the physical world. Other devices, like laptops, desktops and set-top-boxes may be in a better position to understand a user's activities related to commerce and content creation and viewing. The goal of profile storage and distribution is to enable captured context to be securely stored on each platform and shared across platforms to form a unified and broader view of the user. Context sharing across devices might happen directly, either using short range communication mechanisms when devices are in physical proximity, or using wide-area networking technology. Alternatively, a profile storage service 105 can provide a highly-available entity with which all devices share profile information. This profile storage service is an optional component in the architecture can also enable access to the user's profile by online services when the user's devices are offline. The need for this component is dependent on the mobility patterns (Do they periodically come in contact with each other?); and communication capabilities (Do they have wide-area network connectivity most of the time?) of the user's devices.

A user can utilize the context stored on his devices (or on a profile storage service 105) to increase the quality or relevance of services he receives from service providers. These service providers might be delivering their own services (like a bookseller) or aggregating other services (like a book pricing comparison service). The user may choose all or a subset of profile data for varying types of compensation:

No compensation. Just give me better service.

Direct monetary compensation. Cash for context.

Indirect monetary compensation. Give someone else (e.g., a school or charity) cash for context.

Non-monetary compensation. Points, credits, access to free content, or other incentives.

Once the user has chosen to share a subset of context information (which may be referred to herein as a context bundle (or just bundle) 120, 125, the bundle is packaged in such a way that it provides the following qualities:

Only the service provider can access private context in the bundle.

The service provider cannot access the private context until an approval service has determined that the service provider has delivered (or will deliver) the agreed upon compensation.

The approval service cannot access the user's private context.

The service provider can validate that the context in the bundle originated from the user to whom service is being provided.

In the process of facilitating bundle delivery, the approval service 130 may consult with a financial service 135, to either cause payment to be made or to validate that payment has been made. It may also consult with a reputation service 140 to determine if the service provider meets trust criteria specified by the user. Once the approval service has validated that all of the user's conditions have been met, it enables the service provider to access the context. The service provider can then access the delivered context, either to provide better service, or for any other purpose.

Two key pieces of policy control the way in which profile data can be shared with service providers: compensation policy 145, 150 and release policy 155, 160, 165. In an embodiment of the present invention, the compensation policy 145, 150 may describe what compensation the service provider (e.g., Amazon.com 160 and MyCoupon 165) will provide in return for various forms of context. The compensation policy might also specify limitations for how the service provider intends to use this information. In embodiment of the present invention, the release policy 155, 160, 165 describes what information the user is willing to release, to whom, and for what compensation.

There are various types of compensation that must be supported in these policies. Monetary compensation is relatively easy to support. If other forms of compensation are allowed, such as reward/loyalty points or access to free content, then it will be hard to reach agreement between the user and the service provider in any automated manner. It may be possible, although not required, that any conversion between different units of compensation require consulting the user. The complexity of the above policies is determined by types of compensation. If we assume that the only compensation that will be provided to the user is better service, then the release policy need only describe to whom specific pieces of information can be released. The user can adjust the policy if the degree of service improvement is not worth the exposure. The other half of the compensation equation is the context that will be released. Both the service provider and the user have an interest in carefully specifying the type of information that will be released. A wide variety of different categories of information can be released, including demographics (age, gender, etc), location, activity, preferences, goals, and many others. Each piece of information can also be provided at different levels of fidelity or specificity. For example, a location could be exact GPS coordinates, street, city, state, country, or simply that I'm in front of a specific store (but perhaps not exactly which one of a large chain). This information can also be delivered either as a fact, or in response to a query. The latter gives away much less information (e.g., “Are you in front of a Starbucks?” “No.”). Finally, the level of granularity of information that the user is willing to release might be different depending on who (in terms of service providers and/or end users) will receive that information.

From the above, it is clear that specifying exactly what will be released could be very complex and detailed; however, providing this metadata in a very fine level of detail results in both high overhead for the negotiation process and high complexity in specifying policy.

As noted above, compensation policy specifies what context the service provider is interested in, and what the service provider will deliver in return. The service provider may want to specify several different “tiers” of compensation: for a small amount of context a small compensation is delivered, for more context, more compensation is delivered.

In embodiments of the present invention the release policy 155, 160 and 165 may be similar to compensation policy 145, 150 (in reverse), but release policy 155, 160 and 165 also specifies to whom context can be released. Release policy 155, 160 and 165 has the potential to be much more complex than compensation policy. Since the user doesn't know what services he might encounter in advance, there are many more combinations that must be covered in a release policy 155, 160 and 165. With the potential complexity, it is unlikely that users will be willing to specify their release policy 155, 160 and 165 in detail. Several strategies could be employed, individually or in combination, to simplify this task for the user: (1) Allow the user to categorize themselves in terms of their release posture. For instance, categories could be tied to life stages, such as child (ultra-secure), teen (moderate), single adult (open), professional (moderate), retired (ultra-secure). (2) Large amounts of information could be broken down and presented in categories. For instance, context could be categorized in terms of demographics, location, activity, preferences, and goals. Similarly, service providers could be categorized in terms of “my financial institutions,” “my favored merchants,” “other merchants,” “blogs,” “news,” etc. Decisions would be made with respect to categories, rather than individual items. (3) Users could leverage third parties to make certain decisions for them. For example, a reputation service (e.g., McAfee* Site Advisor, Yahoo! Merchant Ratings) could help determine which web services or merchants to trust. Similarly, a service could be designed around helping users understand their privacy risks and define a release policy.

Policy negotiation is the act of finding common ground between the compensation policy 145 and 150 and the release policy 155, 160 and 165. This process begins with the service provider delivering the compensation policy 145, 150 to the client. The client matches the compensation policy 145, 150 to the release policy 155, 160 and 165 on the client device and chooses what information to release. The following describes the manner in which context is negotiated as part of a service exchange. The context delivered to a service provider is called a Bundle 120, 125. The Bundle 120, 125 is a subset of information available from the user's profile that has been protected in such a way that the service provider 160, 165 alone can get at the information, only once the promised compensation has been rendered. An embodiment of the present invention provides an exchange in which context is delivered directly from the client platform. This platform is both available (presuming it's making the request in real time) as well as current (since the user is using it, it likely has the latest profile information). In the case that the platform is either not available or current, a second mechanism by which a service provider could request a user profile from a profile storage service 105, which may include release policy 160 and profile store 175, is provided.

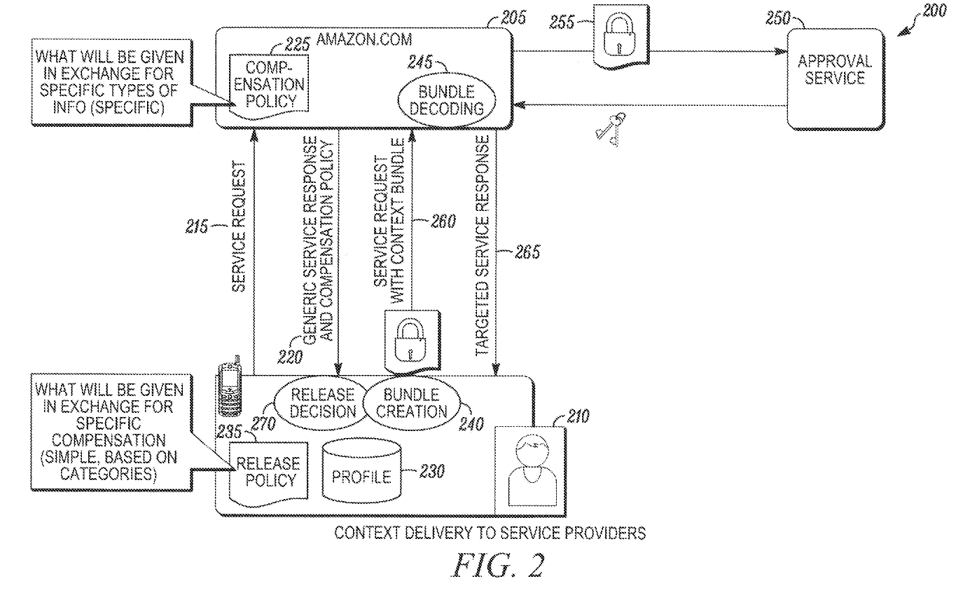

Embodiments of the present invention provide delivering context from devices and is illustrated generally as 200 of FIG. 2, which shows a high-level view of the exchange that would enable a user profile bundle to be delivered to a service provider 205 from the client 210 as part of the service exchange. Service is initially requested by the client 210 in a generic service request 215, as completed in today's service-oriented architectures. The service provider 205 then delivers a generic (context independent) response 220. Along with this response, the compensation policy 225 is returned stating what the service provider 205 can offer in return for various portions of user profile 230. At this point, the client 210 can choose to either continue to use the generic service or to deliver a bundle in return for compensation (which might simply be better service). This decision 270 is made by comparing the compensation policy 225 against the release policy 235. Note that the bundle may be delivered directly from the platform. It is not necessary for the application to be involved in policy resolution or bundle generation, thus potentially protecting the user from malware. If the user chooses to release a portion of his profile 230, a bundle is generated 240 on the client and delivered in a second service request 260 to the service provider 205, who attempts to decode the bundle 245. At this point, the service provider 205 authenticates the data as coming from the client user 210; but the service provider cannot access the bundle data without prior approval by the approval service provider 250. The service provider 205 ships part, or all, of the bundle 255 to the approval service provider, who, if all conditions have been met, returns sufficient information to allow the service provider to access the bundle data. More details of this exchange are provided below.

Once the bundle 255 has been successfully decoded, the service provider 205 provides a service response 265 that is targeted specifically to the user. Included in this response is a session ID, perhaps delivered in an HTTP header. Since existing web applications typically embed session IDs as a session cookie, session IDs of the present architecture could either leverage or be placed alongside of an existing session ID. This session ID can be delivered in future service requests until the bundle data 255 become stale, at which point a new bundle can be negotiated. The service provider may periodically request the user to send updated context data using a similar mechanism to the original request.

Embodiments of the present invention enable delivering context from a profile storage service as introduced previously related to FIG. 1 at 105. In some cases, it may be more appropriate for the service to receive the profile from a profile storage service, rather than directly from the client. This occurs if the service is being delivered while the client is offline (e.g., a service that watches prices for purchasing opportunities while the user is offline) or if the client device does not have the most recent profile information (perhaps the user just switched devices). In this case, rather than delivering a bundle to a service provider, the client delivers a pointer to a profile storage service from which the service provider can obtain the bundle. Several additional mechanisms are required: The user must be able to pre-authorize the profile service provider to share specific pieces of information to a particular service provider. This would likely occur using the release policy 160 stored in the profile storage service 105. The profile storage service must be able to respond to direct requests for bundles, likely via a web services interface. A token (which, in an embodiment of the present invention may be delivered in the initial request above) may be needed to thwart fishing attacks on the profile storage service.

Embodiments of the present invention provide bundle access as set forth above and elaborated herein. The following provides a possible embodiment of some of the cryptographic primitives and information exchanges that might be needed to achieve the desired privacy and authenticity properties, although the present invention is not limited in this respect. A bundle is a package of information delivered from a client to a service provider that has the following properties:

Authenticated as originating from the client user;

Contains profile information that can only be accessed by the service provider and only after approval by the Approval Service;

Contains metadata, accessible only by the service provider, which specifies what profile information is included in the bundle;

Includes a policy that specifies what the user expects in return for release of the profile data; and

Includes a specification of how payment will be rendered.

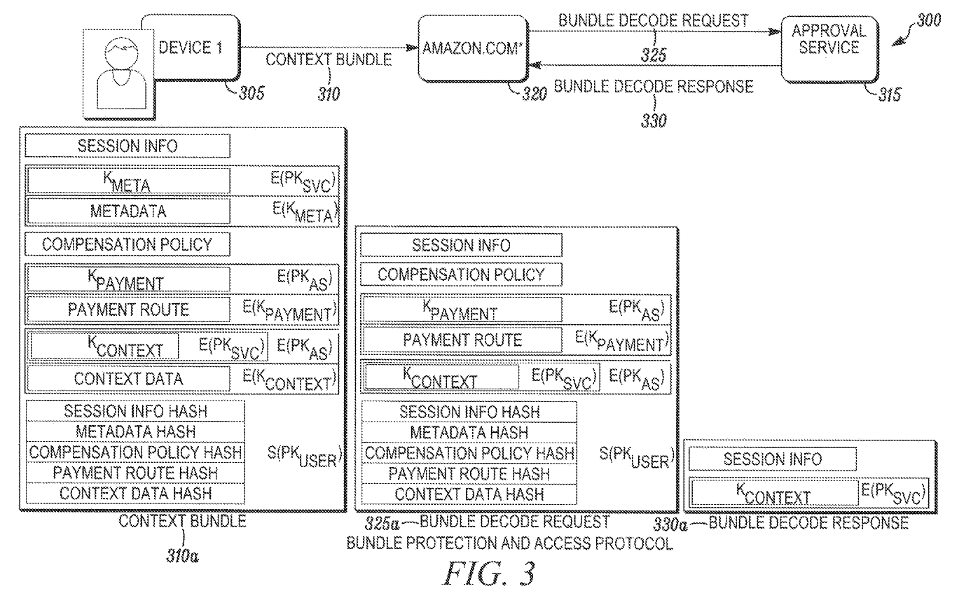

These properties are implemented in an exchange between the service provider and Approval Service Provider, as shown generally as 300 of FIG. 3. The bundle of FIG. 3 includes several components. The contextual information in the bundle is protected with a session key (K_CONTEXT). This session key is generated by the client 305. The session key (K_CONTEXT) which is double encrypted (by the service provider and the Approval Service public keys) is included in the package 310. Only through cooperation with the approval service 315 can the service provider 320 obtain the key. The policy information is signed using the user or device's private key (PK_USER), authenticating this information for use by the approval service 315. The payment route is encrypted by the public key of the approval service (PK_AS), so that it can validate that proper payment has occurred (or make payment). The metadata is encrypted using the service provider's public key (PK_SVC). Only the service provider 320 can decode the metadata in order to determine whether or not to pay for the context in the bundle. In embodiments of the present invention, the bundle format 310 (elaborated at 310a) assumes XML-digsig or similar construct where multiple data elements can be referenced independently by a single signature. Signed elements not relevant to a particular party can be stripped before sending and the signature can still be verified. Once the bundle is delivered to the service provider, the service provider 320 (1) determines the authenticity of the bundle by checking the digital signature on the context, and (2) examines the metadata to determine if it wishes to pay for the contained context. If it wishes to proceed, the service provider makes payment (if necessary) and forwards a bundle decode request 325 (elaborated on at 325a) to the approval service 315, with proof of payment (or request for the approval service to make payment). The approval service 315 first validates the policy has been satisfied (payment has been delivered if appropriate). This is also an opportunity for the approval service 315 to obtain payment and/or for the platform vendor to be paid for delivering the context and any context analysis. The approval service 315 then partially decrypts the session key. Note that the session key is still partly encrypted by the service provider's public key. The approval service 315 sends the service provider this partly decrypted key (and perhaps other information as shown FIG. 3) at 330 (elaborated on at 330a). The service provider 320 can now decode the session key and obtain the context from the bundle. The above procedure has the following properties: The approval service 315 never has access to user context; Only the designated service provider can obtain access to context, and only with approval from the Approval Service; Multiple levels of context can optionally be included, each protected by a different session key; This exchange can occur once per “session,” and refreshed periodically when the contextual profile becomes stale.

The overhead of the encoding and decoding of bundle-related messages is as follows:

Building the bundle may require 5 asymmetric key operations and 4 symmetric key operations (including symmetric component of double Kcontext wrap), although the present invention is not limited in this respect.

Verifying and decrypting the bundle at the Approval Service requires 3 asymmetric key operations and 2 symmetric key operations in one embodiment and not limited to these specific keys.

Verifying and decrypting the bundle at the service provider requires 3 asymmetric key operations and 2 symmetric key operations. Note that this architecture has suggested the use of a personal or device-specific signing key on hashes to authenticate data, which may reveal the user's identity. Architectures of embodiments of the present invention may consider user identity in more depth.

Embodiments of the present invention provide a profile layout. The information contained in the profile is relatively independent of the above discussion. However, some questions must be answered. What are the levels of granularity that profile information can take, so that we can provide the correct level of granularity for protection of that information? In addition, what types of queries to profile information that services will want to make? Which profiles must be segmented across user domains (work, home, etc). This information must be obtained by surveying service providers.

Many users have multiple personal devices. Complimentary to the embodiments provided above, those devices each independently collect information about the user, including explicit user preferences, how they use the device, what data they store and access via the device, and information about the user (what appointments they have on their calendar, where they go physically, what activities they do, what they buy, etc). Typically this information is held independently on each device.

Embodiments of the present invention unifies the personal information about a user that is gathered on their collection of personal devices. This information can then be used to drive a personalized experience for the user that is consistent across platforms, including personalized recommendations. Further embodiments of the present invention may provide a profile storage. The goal of profile storage is to securely maintain a version of the user's profile on each of his platforms, called a profile store. Each platform owned by the user will store a local version of the user's profile in the profile store shown as 170, 175, and 167 of FIG. 1. Over time, each profile store 170, 175, and 167 will be updated in two ways: First the profile will typically be updated using user context acquired locally by the platform. Second, the user's platforms may communicate for the purpose of synchronizing information between profile stores, thus building up a unified user profile. For example, the user's smart phone may learn about the types of retail stores the user frequents by observing his location over time. His PC on the other hand, may learn about his online shopping habits by watching his web browsing patterns. Each of these devices will build up a profile about the user in their respective profile stores: the smart phone will store a mobile shopping profile and the PC will store an online shopping profile. Periodically, these two devices will synchronize their profiles (perhaps using the user's home network), building a more complete profile of the user's shopping needs and habits. Note that a given device can store profiles for multiple users. This is true for two reasons. First, a given device may be used by multiple users. Thus, identifying the user currently operating the device is a key platform capability. Second, a user's current activities may not always be related to himself. In the shopping example above, the user may be shopping for himself, or he may be purchasing a gift or running an errand for someone else. Similarly, if the user is with other people, his location may be attributed to someone he's with (e.g., he may be accompanying someone else who is shopping). Thus, understanding who the user is with, as well as the user's social relationships, is important to allow profile information to be attributed to the correct profile. In addition to profile data, the profile store also contains policy information that specifies how information for the profile store can be used. This information is used to control information release and is described above.

Modification of this policy information should only be allowed via direct user action (and not, for example, by a service acting on behalf of the user). As noted above, each device maintains a profile store, which contains a subset of information about the user. Periodically, devices communicate to share information and reconcile differences between profile stores. This communication may occur using a local area networking technology (when the devices are near each other) or via a wide-area networking technology (when the devices are distant), although the present invention is not limited in this respect. In an embodiment of the present invention, the user must explicitly approve sharing of profile information between profile stores on trusted devices, likely requiring configuration of some trust relationship between each device/store. The collection of profile stores can be thought of as distributed replicated databases, each of which has a slightly different set of information. While the ultimate goal is to create a single profile or view of the user, at any given moment, each device will have a slightly different set of information available for two reasons: First, recent information may be present locally that has not yet been shared with other devices. Second, the user may choose to allow only a subset of information to reside on any particular device (often referred to as selective replication). For example, context stemming from work-related activities may be confined to devices owned by the user's employer.

When profile stores share information, they must reconcile their differing viewpoints (just as distributed replicated databases do). This process will not simply consist of copying new bits information from one device to the other. Instead a highly application specific merge of differing user profiles into a single consistent view will likely be required. There are two likely topologies of communication between profile stores: star and fully connected. In a star topology, as in a master/slave replication topology, all devices must share information with a single master profile store. The master profile store would likely be the user's PC or a cloud profile storage service. In a fully connected topology, any profile store is free to share information with any other profile store. In this case, no master profile store is required. In either case, it is important that the communication topology forms a connected graph over the course of some time period (say every few days). A profile storage service that is available in the cloud can help facilitate communication between profile stores on devices, as described below.

As set forth above and elaborated herein, embodiments of the present invention may provide using a profile storage service as shown in 105 of FIG. 1. Each user device that supports user profiling may include a secure profile store. In addition, it may be desirable for one or more cloud services to maintain a secure version of the user's profile store. Such a profile storage service would be highly available, at least via wide-area networking. Thus, it could facilitate communication between highly mobile profile stores, which would likely have very low availability. In addition, it could serve profile data to cloud services on the user's behalf when no other copies of the user's profile are available. Functions of the profile storage service include the following: (1) Maintain a profile store containing user profile information. (2) Provide a profile discovery mechanism. It may be desirable for service providers to be able to locate profile service providers that can serve a particular profile. However, this information may only be provided if authorized in the user's release policy. In addition, it may be desirable to utilize an anonymous user-specific token with a large namespace to thwart fishing. (3) Reconcile profile information with other profile stores, when contacted. Authorization to share information with other profile stores, or other profile storage services, must be provided directly by the user. (4) Respond to requests for context information, in accordance with the user's release policy. Note that the cloud store may not specify or modify the user's release policy, and as such, release may only occur in accordance with the existing release policy. Release cannot occur in cases in which additional user intervention would be required.

Thus, embodiments of the present invention may provide a system, comprising a first information assimilation and communication platform adapted to capture context information of a user and securely store the context on the first platform, at least one additional information assimilation and communication platform adapted to capture and share context information with the first information platform to form a unified and broader view of the user; and wherein the first or the at least one additional information assimilation and communication platform is configured to distribute the context information to a service provider, wherein the service provider provides an incentive to the user for the context information.

While certain features of the invention have been illustrated and described herein, many modifications, substitutions, changes, and equivalents may occur to those skilled in the art. It is, therefore, to be understood that the appended claims are intended to cover all such modifications and changes as fall within the true spirit of the invention.

We claim:

1. A method of offering incentive based context to service providers, comprising:
capturing context information of a user and distributing said context information to said service provider, wherein said service provider provides an incentive to said user for said context information; and
wherein said user may choose all or a subset of said context information data for varying types of compensation selected from the group consisting of:
No compensation;
Direct monetary compensation;
Indirect monetary compensation;
Non-monetary compensation; or
Points, credits, access to free content.

2. The method of claim 1, further comprising using a secure profile storage service to provide a highly-available entity with which all devices share profile information, wherein said profile storage service enables access to a user's profile by online services when a user's devices are offline.

3. The method of claim 1, wherein once said user has chosen to share a subset of said context information, said context information is packaged in such a way that it provides one or more of the following:
Only the service provider can access private context;
The approval service cannot access the user's private context;
The service provider can only access the private context once the approval service has authorized access; or
The service provider can validate that the context originated from the user to whom service is being provided.

4. The method of claim 1, further comprising integrating an approval service to verify authorization for access to said user context.

5. A method of offering incentive based context to service providers, comprising:
capturing context information of a user and distributing said context information to said service provider, wherein said service provider provides an incentive to said user for said context information;
integrating an approval service to verify authorization for access to said user context information; and
wherein said approval service consults with a financial service, to either cause payment to be made or to validate that payment has been made.

6. A method of offering incentive based context to service providers, comprising:
capturing context information of a user and distributing said context information to said service provider, wherein said service provider provides an incentive to said user for said context information;
integrating an approval service to verify authorization for access to said user context information, said approval service consulting with a reputation service to determine if said service provider meets a trust criteria specified by said user and wherein once said approval service has validated that all of said user's conditions have been met, it enables said service provider to access said user context.

7. The method of claim 6, further comprising using a policy specification and wherein said policy specification utilizes two key pieces of policy control for a way in which said profile data can be shared with said service providers which include a compensation policy and a release policy and wherein said compensation policy describes what compensation said service provider will provide in return for various forms of context and wherein said release policy describes what information said user is willing to release, to whom, and for what compensation.

8. The method of claim 1, wherein a wide variety of different categories of context information can be released, including demographics, location, activity, preferences, goals, and many others and wherein each piece of information can also be provided at different levels of fidelity or specificity.

9. The method of claim 7, wherein said release policy is implemented using one or more of the strategies selected from the group consisting of:
Allow the user to categorize themselves in terms of their release posture;
Large amounts of information could be broken down and presented in categories; or
Users could leverage third parties to make certain decisions for them.

10. The method of claim 7, further comprising using policy negotiation to find common ground between said compensation policy and said release policy, wherein said service provider delivers said compensation policy to said user and said user matches said compensation policy to said release policy on said users device and chooses what information to release.

11. The method of claim 1, further comprising creating a secure profile store to maintain a version of said user's profile on each of a plurality of platforms said user may be using, wherein said platforms owned by said user will store a local version of said user's profile in said profile store.

12. A method of offering incentive based context to service providers, comprising:
capturing context information of a user and distributing said context information to said service provider, wherein said service provider provides an incentive to said user for said context information;
creating a secure profile store to maintain a version of said user's profile on each of a plurality of platforms said user may be using, wherein said platforms owned by said user will store a local version of said user's profile in said profile store; and
wherein each profile store is updated using said user context acquired locally by said first platform and said user's at least one addition platform communicates for the purpose of synchronizing information between profile stores, thus building up a unified user profile.

13. The method of claim 12, wherein a given device can securely store profiles for multiple users and wherein in addition to profile data, said profile store also contains policy information that specifies how information for said profile store can be used and wherein this information is used to control information release.

14. The method of claim 13, wherein each device maintains a secure profile store, which contains a subset of information about said user and periodically, said devices communicate to share information and reconcile differences between profile stores and wherein said communication is capable of using a local area networking technology or via a wide-area networking technology and wherein said user must explicitly approve sharing of profile information between profile stores on trusted devices.

15. The method of claim 14, wherein profile stores share information by using a highly application specific merge of differing user profiles into a single consistent view consisting of star and fully connected topologies of communication.

16. The method of claim 15, wherein functions of said profile storage service include:
Maintaining a profile store containing user profile information;
Providing a profile discovery mechanism;
Reconciling profile information with other profile stores, when contacted; or
Responding to requests for context information, in accordance with the user's release policy.

17. A non-volatile computer readable medium encoded with computer executable instructions, which when accessed, cause a machine to perform operations comprising:
capturing context information of a user and distributing said context information to said service provider, wherein said service provider provides an incentive to said user for said context information; and
wherein said user may choose all or a subset of said context information for varying types of compensation selected from the group consisting of:
No compensation;
Direct monetary compensation;
Indirect monetary compensation;
Non-monetary compensation; or
Points, credits, access to free content.

18. The computer readable medium encoded with computer executable instructions of claim 17, further comprising using a profile storage service to provide a highly-available entity with which all devices share profile information, wherein said profile storage service enables access to a user's profile by online services when a user's devices are offline.

19. The computer readable medium encoded with computer executable instructions of claim 17, wherein once said user has chosen to share a subset of said context information, said context information is packaged in such a way that it provides one or more of the following:
Only the service provider can access private context;
The approval service cannot access the user's private context;
The service provider can only access the private context once the approval service has authorized access; or
The service provider can validate that the context originated from the user to whom service is being provided.

20. The computer readable medium encoded with computer executable instructions of claim 18, further comprising integrating an approval service to verify authorization for access to said user context.

21. A non-volatile computer readable medium encoded with computer executable instructions, which when accessed, cause a machine to perform operations comprising:
capturing context information of a user and distributing said context information to said service provider, wherein said service provider provides an incentive to said user for said context information;
integrating an approval service to verify authorization for access to said user context information; and
wherein said approval service consults with a financial service, to either cause payment to be made or to validate that payment has been made.

22. A non-volatile computer readable medium encoded with computer executable instructions, which when accessed, cause a machine to perform operations comprising:
capturing context information of a user and distributing said context information to said service provider, wherein said service provider provides an incentive to said user for said context information;
integrating an approval service to verify authorization for access to said user context information, said approval service consulting with a reputation service to determine if said service provider meets a trust criteria specified by said user; and
wherein once said approval service has validated that all of said user's conditions have been met, it enables said service provider to access said user context.

23. The computer readable medium encoded with computer executable instructions of claim 22, further comprising using a policy specification and wherein said policy specification utilizes two key pieces of policy control for a way in which said profile data can be shared with said service providers which include a compensation policy and a release policy and wherein said compensation policy describes what compensation said service provider will provide in return for various forms of context and wherein said release policy describes what information said user is willing to release, to whom, and for what compensation.

24. The computer readable medium encoded with computer executable instructions of claim 23, wherein a wide variety of different categories of context information can be released, including demographics, location, activity, preferences, goals, and many others and wherein each piece of information can also be provided at different levels of fidelity or specificity.

25. The computer readable medium encoded with computer executable instructions of claim 24, wherein said release policy is implemented using one or more of the strategies selected from the group consisting of:
Allow the user to categorize themselves in terms of their release posture;
Large amounts of information could be broken down and presented in categories; or
Users could leverage third parties to make certain decisions for them.

26. The computer readable medium encoded with computer executable instructions of claim 23, further comprising using policy negotiation to find common ground between said compensation policy and said release policy, wherein said service provider delivers said compensation policy to said user and said user matches said compensation policy to said release policy on said users device and chooses what information to release.

27. The computer readable medium encoded with computer executable instructions of claim 17, further comprising creating a secure profile store to maintain a version of said user's profile on each of a plurality of platforms said user may be using, wherein said platforms owned by said user will store a local version of said user's profile in said profile store.

28. The computer readable medium encoded with computer executable instructions of claim 27, wherein each profile store is updated using said user context acquired locally by a first platform and said user's at least one addition platform communicates for the purpose of synchronizing information between profile stores, thus building up a unified secure user profile.

29. The computer readable medium encoded with computer executable instructions of claim 28, wherein a given device can store profiles for multiple users and wherein in addition to profile data, said profile store also contains policy information that specifies how information for said profile store can be used and wherein this information is used to control information release.

30. The computer readable medium encoded with computer executable instructions of claim 29, wherein each device maintains a profile store, which contains a subset of information about said user and periodically, said devices communicate to share information and reconcile differences between profile stores and wherein said communication is capable of using a local area networking technology or via a wide-area networking technology and wherein said user must explicitly approve sharing of profile information between profile stores on trusted devices.

31. The computer readable medium encoded with computer executable instructions of claim 30, wherein profile stores share information by using a highly application specific merge of differing user profiles into a single consistent view consisting of star and fully connected topologies of communication.

32. The computer readable medium encoded with computer executable instructions of claim 31, wherein functions of said profile storage service include:
Maintaining a profile store containing user profile information;
Providing a profile discovery mechanism;
Reconciling profile information with other profile stores, when contacted; or
Responding to requests for context information, in accordance with the user's release policy.

33. A system, comprising:
an information assimilation and communication platform adapted to capture context information of a user and securely store said context on said platform;
wherein said information assimilation and communication platform is configured to distribute said context information to a service provider, wherein said service provider provides an incentive to said user for said context information; and
wherein said user may choose all or a subset of said context information for varying types of compensation selected from the group consisting of:
No compensation;
Direct monetary compensation;
Indirect monetary compensation;
Non-monetary compensation; or
Points, credits, access to free content.

34. The system of claim 33, further comprising a profile storage service to provide a highly-available entity with which all devices share profile information, wherein said profile storage service enables access to a user's profile by online services when a user's devices are offline.

35. The system of claim 34, wherein once said user has chosen to share a subset of said context information, said context information is packaged in such a way that it provides one or more of the following:
Only the service provider can access private context;
The approval service cannot access the user's private context;
The service provider can only access the private context once the approval service has authorized access; or
The service provider can validate that the context originated from the user to whom service is being provided.

36. The system of claim 32, further comprising an approval service to verify authorization for access to said user context.

37. A system, comprising:
an information assimilation and communication platform adapted to capture context information of a user and securely store said context on said platform;
wherein said information assimilation and communication platform is configured to distribute said context information to a service provider, wherein said service provider provides an incentive to said user for said context information; and
an approval service to verify authorization for access to said user context; said approval service consults with a financial service, to either cause payment to be made or to validate that payment has been made.

38. A system, comprising:
an information assimilation and communication platform adapted to capture context information of a user and securely store said context on said platform;
wherein said information assimilation and communication platform is configured to distribute said context information to a service provider, wherein said service provider provides an incentive to said user for said context information; and
an approval service to verify authorization for access to said user context, said approval service consulting with a reputation service to determine if said service provider meets a trust criteria specified by said user and wherein once said approval service has validated that all of said user's conditions have been met, it enables said service provider to access said user context.

39. The system of claim 38, further comprising using a policy specification and wherein said policy specification utilizes two key pieces of policy control for a way in which said profile data can be shared with said service providers which include a compensation policy and a release policy and wherein said compensation policy describes what compensation said service provider will provide in return for various forms of context and wherein said release policy describes what information said user is willing to release, to whom, and for what compensation.

40. The system of claim 33, wherein a wide variety of different categories of context information can be released, including demographics, location, activity, preferences, goals, and many others and wherein each piece of information can also be provided at different levels of fidelity or specificity.

41. The system of claim 39, wherein said release policy is implemented using one or more of the strategies selected from the group consisting of:
Allow the user to categorize themselves in terms of their release posture;
Large amounts of information could be broken down and presented in categories; or
Users could leverage third parties to make certain decisions for them.

42. The system of claim 39, further comprising using policy negotiation to find common ground between said compensation policy and said release policy, wherein said service provider delivers said compensation policy to said user and said user matches said compensation policy to said release policy on said users device and chooses what information to release.

43. The system of claim 33, further comprising a secure profile store created to maintain a version of said user's profile on each of a plurality of platforms said user may be using, wherein said platforms owned by said user will store a local version of said user's profile in said profile store.

44. The system of claim 43, wherein each secure profile store is updated using said user context acquired locally by a first platform and said user's at least one addition platform communicates for the purpose of synchronizing information between profile stores, thus building up a unified user profile.

45. The system of claim 44, wherein a given device can securely store profiles for multiple users and wherein in addition to profile data, said profile store also contains policy information that specifies how information for said profile store can be used and wherein this information is used to control information release.

46. The system of claim 45, wherein each device maintains a secure profile store, which contains a subset of information about said user and periodically, said devices communicate to share information and reconcile differences between profile stores and wherein said communication is capable of using a local area networking technology or via a wide-area networking technology and wherein said user must explicitly approve sharing of profile information between profile stores on trusted devices.

47. The system of claim 46, wherein secure profile stores share information by using a highly application specific merge of differing user profiles into a single consistent view consisting of star and fully connected topologies of communication.

48. The system of claim 47, wherein functions of said secure profile storage service include:
Maintaining a profile store containing user profile information;
Providing a profile discovery mechanism;
Reconciling profile information with other profile stores, when contacted; or
Responding to requests for context information, in accordance with the user's release policy.
